(19) United States
(12) Patent Application Publication
(10) Pub. No.: US 2010/0096938 A1
(43) Pub. Date: Apr. 22, 2010

(54) BLOWER MOTOR

(76) Inventors: Tadashi YANO, Ueda-shi (JP); Akihito Fukuzawa, Ueda-shi (JP)

Correspondence Address: BIRCH STEWART KOLASCH & BIRCH, PO BOX 747, FALLS CHURCH, VA, 22040-0747, US

(21) Appl. No.: 12/579,102

(22) Filed: Oct. 14, 2009

(30) Foreign Application Priority Data
Oct. 15, 2008 (JP) 2008-266454

(51) Int. Cl. H02K 5/18

(52) U.S. Cl. 310/64

(57) ABSTRACT

A blower motor can efficiently remove heat generated by all substrate-mounted components. A rotor and a stator are housed inside a motor case. A motor substrate on which a motor driving circuit is formed is disposed in a space formed in the axial direction between (i) the rotor and the stator and (ii) an opening bottom portion of a bracket. A heat-generating component mounted on the motor substrate contacts the opening bottom portion of the bracket via a heat-dissipating member.

### CROSS-REFERENCE TO RELATED APPLICATIONS

This application is based upon and claims the benefit of priority of the prior Japanese Patent Application No. 2008-266454, filed on 15 Oct. 2008, the entire contents of which are incorporated herein by reference.

### FIELD

The present invention relates to a blower motor used for example in a vehicle air conditioner, a battery cooling apparatus, and the like.

### BACKGROUND

As one example, the construction of an outer-rotor blower motor (DC brushless motor) used as the driving apparatus of a vehicle air-conditioner apparatus will now be described with reference to FIG. 6.

A stator is fixed to a motor holder 51 and an output shaft 52 is rotatably supported by a bearing portion. Although not illustrated, a rotor, constructed with magnets attached to the inner circumferential surface of a cup-shaped rotor yoke, is attached to the output shaft 52 so as to surround the stator.

A fan (impeller) 53 is attached to one end of the output shaft 52. The other end of the output shaft 52 extends to a lower case 54 that covers the motor holder 51. A motor substrate 55 is housed between the motor holder 51 and the lower case 54. A driving circuit (excitation circuit) for a DC brushless motor is provided on the motor substrate 55.

An output transistor (switching element) 56 such as a FET that switches an excitation current is provided on the motor substrate 55, and a heat sink (radiator) 57 that is exposed to the outside from the motor holder 51 is assembled so as to contact heat-generating components such as the output transistor 56. The heat that is transferred to the heat sink 57 from the heat-generating components such as the output transistor 56 is dissipated into the atmosphere by a cooling air-flow generated by rotation of the fan 53 (see Patent Document 1).
Patent Document 1
   Japanese Laid-Open Patent Publication No. H11-332203

### SUMMARY

In the blower motor described above, the fan 53 that is provided above the motor holder 51 and the motor substrate 55 that is provided inside the lower case 54 disposed below the motor holder 51 are located so as to be separated in the axial direction. For this reason, the heat sink (radiator) 57 is assembled so as to contact the heat-generating component (the FET 56) that is mounted on the motor substrate 55, and by having the heat sink 57 exposed to the outside of the motor holder 51, heat is dissipated to the atmosphere using a cooling air-flow produced by the fan 53. However, there is no means for efficiently removing the heat generated from electronic components mounted on the motor substrate 55 aside from the heat-generating component (the FET 56).

The present invention was conceived to solve the problem described above and it is an object of the present invention to provide a blower motor that is capable of efficiently removing heat generated from all of the substrate-mounted components.

To achieve the stated object, a blower motor according to the present invention includes a motor case produced by attaching a cup-shaped bracket so as to cover an attachment base; a motor shaft that protrudes out of the motor case; and a fan that is attached to the motor shaft, wherein a rotor and a stator are housed inside the motor case, a motor substrate, on which a motor driving circuit is formed, is disposed in a space formed in an axial direction between (i) the rotor and the stator and (ii) an opening bottom portion of the bracket, and a heat-generating component mounted on the motor substrate contacts the opening bottom portion of the bracket via a heat-dissipating member.

A heat-dissipating surface on an opposite side of the bracket to a surface contacted by the heat-generating component may be formed with a convex and concave surface by forming at least one of radial channel portions and dotted concave portions.

The motor substrate may be fixed adjacent to the opening bottom portion of the bracket and the bracket may be connected to earth by being connected to substrate wiring formed on the motor substrate.

By using the blower motor described above, the rotor and stator are housed inside the motor case produced by attaching the bracket so as to cover the attachment base, the motor substrate, on which the motor driving circuit is formed, is disposed in the space formed in an axial direction between (i) the rotor and the stator and (ii) the opening bottom portion of the bracket, and the heat-generating component mounted on the motor substrate contacts the opening bottom portion of the bracket via the heat-dissipating member.

By doing so, it is possible to transfer the heat generated by the heat-generating component via the heat-dissipating member to the bracket and to dissipate the heat via the entire surface of the bracket to the atmosphere. Also, since a fan is attached to the motor shaft that protrudes from the surface of the bracket, when the fan rotates, a cooling air-flow is directed onto the bracket and therefore the heat generated from the entire substrate can be efficiently dissipated. By flattening the motor in the axial direction, it is possible to increase the heat-dissipating area of the bracket, which means that heat can be efficiently removed.

Also, by forming the heat-dissipating surface on the opposite side of the bracket to the surface contacted by the heat-generating component with a convex and concave surface by forming at least one of radial channel portions and dotted concave portions, it is possible to increase the surface area of the heat-dissipating surface and thereby improve the heat-dissipating performance.

Also, the motor substrate may be fixed adjacent to the opening bottom portion of the bracket and the bracket may be connected to earth by being connected to substrate wiring formed on the motor substrate. By doing so, it is possible to prevent the electrical corrosion of bearing portions provided on the bracket due to the accumulation of static electricity and to thereby improve durability.

### BRIEF DESCRIPTION OF DRAWINGS

FIG. 1 is a schematic view (half in cross-section) of a blower motor to which a fan has been attached;

FIG. 2 is a cross-sectional schematic view of a blower motor from which the fan has been removed;

FIG. 3 is an enlarged cross-sectional view of a part where a heat-generating component mounted on a substrate contacts a bracket;

FIGS. 4A and 4B are cross-sectional schematic diagrams depicting a construction for suppressing motor vibration and depicting how the bracket is connected to earth;

FIGS. 5A to 5F are perspective views depicting the form of a heat-dissipating surface of the bracket; and

FIG. 6 is a schematic view (half in cross-section) of a conventional outer-rotor motor.

### DESCRIPTION OF EMBODIMENTS

A preferred embodiment of a blower motor will now be described with reference to the attached drawings. The present embodiment will be described by way of a blower motor (i.e., an outer-rotor DC brushless motor) for use in a vehicle.

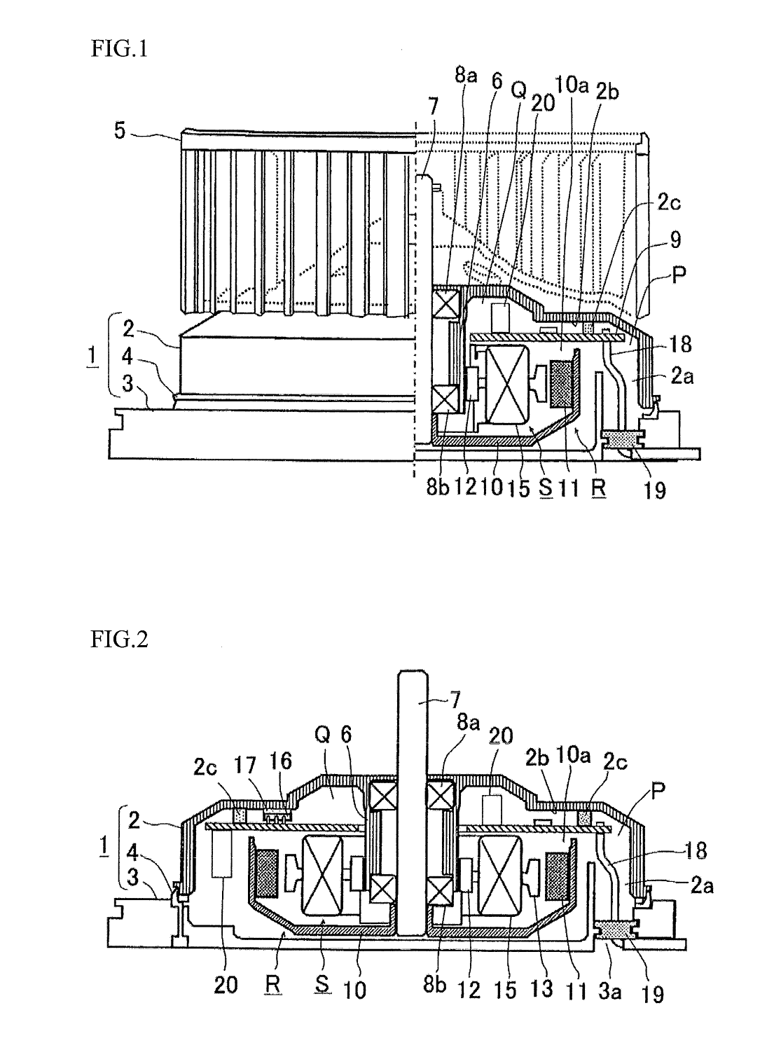

The overall construction of a blower motor will now be described with reference to FIGS. 1 and 2.

As depicted in the left half of FIG. 1, a blower motor 1 is produced by integrally assembling a cup-shaped bracket 2 and an attachment base 3 with a seal member (made, for example, of an elastic resin material such as an elastomer) 4 in between. A fan (impeller) 5 is integrally attached to one end of a motor shaft, described later, in the periphery of the bracket 2. When the fan 5 rotates, air is drawn from a central part in the axial direction and expelled outward.

As depicted in the right half of FIG. 1, a hollow cylindrical portion 6 is provided so as to protrude into the center of a bracket opening 2a of the cup-shaped bracket 2. Inside the hollow cylindrical portion 6, a motor shaft 7 is rotatably supported via bearing portions (ball bearings, sleeve bearings, or the like) 8a, 8b. The bracket 2 serves as both the rotor bearing portion and the motor case. Aside from an aluminum die-cast product (foundry product) that is lightweight and favorably dissipates heat, it is possible to use cold-rolled steel sheet (SPCC) or the like. A metal cup member (for example, an aluminum bracket) is favorably used. A rotor R and a stator S are housed inside a closed space P that is closed by forming the bracket 2 so as to cover the attachment base 3 with the seal member 4 in between.

Also, a motor substrate (PWB) 9 on which a motor driving circuit is formed is fixed in a space Q formed in the axial direction between (i) the rotor R and the stator S and (ii) an opening bottom portion 2b of the bracket 2 by being screwed to screw holes of boss portions 2c provided at a plurality of positions on the opening bottom portion 2b. Since the motor substrate 9 can be fixed both adjacent to the opening bottom portion 2b of the bracket 2 and within a range in the axial direction that is inside the motor case surrounded by the bracket 2 and the attachment base 3 that construct the exterior of the motor, it is possible to miniaturize and flatten the blower motor 1 in the axial direction and to reduce the weight of the blower motor 1. It is also possible to electrically connect the bracket 2 and the motor substrate 9 via the boss portions 2c and/or the screws (not illustrated) and thereby connect the bracket 2 to earth. By doing so, electrical corrosion of the bearing portions 8a, 8b provided in the hollow cylindrical portion 6 is prevented, thereby improving durability. Note that although the motor substrate 9 may be fixed to the hollow cylindrical portion 6, to prevent vibration at an outer edge portion of the substrate, fixing the motor substrate 9 at the outer edge portion thereof is preferable. Also, the motor substrate 9 does not need to be directly attached to the bracket 2 and may be fixed using screws or the like to an insulator of the stator S that is attached to the hollow cylindrical portion 6.

Magnets 11 are joined with adhesive to an inner circumferential surface of a cup-shaped rotor yoke 10 of the rotor R. A center portion of the rotor yoke 10 and the other end of the motor shaft 7 are integrally combined. The rotor R is rotatably assembled on the bracket 2 with a rotor yoke opening 10a facing the opening bottom portion 2b of the bracket 2 and with the motor shaft 7 supported via the bearing portions 8a, 8b on the hollow cylindrical portion 6 formed on the opening bottom portion 2b of the bracket 2. Since the stator S is disposed in a space formed by housing the rotor yoke 10 inside the bracket opening 2a so that the rotor yoke opening 10a faces the opening bottom portion 2b, it is possible to reduce the height of the blower motor 1 in the axial direction in spite of the blower motor 1 being an outer-rotor motor.

In FIG. 2, a ring-shaped stator core 12 is attached onto an outer circumferential surface of the hollow cylindrical portion 6 that is formed on the opening bottom portion 2b of the bracket 2. Teeth portions 13 are provided on the stator core 12 so as to point inward in the radial direction and each tooth portion 13 is insulated by being covered with an insulator, not illustrated. Magnet wire 15 is wound around each tooth portion 13.

In FIG. 2, electronic components (as examples, a choke coil and an electrolytic capacitor 20) that are comparatively high are disposed on the motor substrate 9 in a free space formed in the bracket opening 2a either close to the center in the radial direction of the opening bottom portion 2b or close to the outer edge on the outside of the rotor yoke 10 in the radial direction. Electronic components that generate a large amount of heat (for example, a switching element such as a FET) are disposed in an intermediate region (a region where the boss portions 2c are formed) where the motor substrate 9 is adjacent to the opening bottom portion 2b. By doing so, it is possible to accommodate the height of the substrate-mounted components in the axial direction using the free space inside the bracket opening 2a on both sides of the substrate, which makes it possible to further flatten the motor (i.e., to make the motor slimmer).

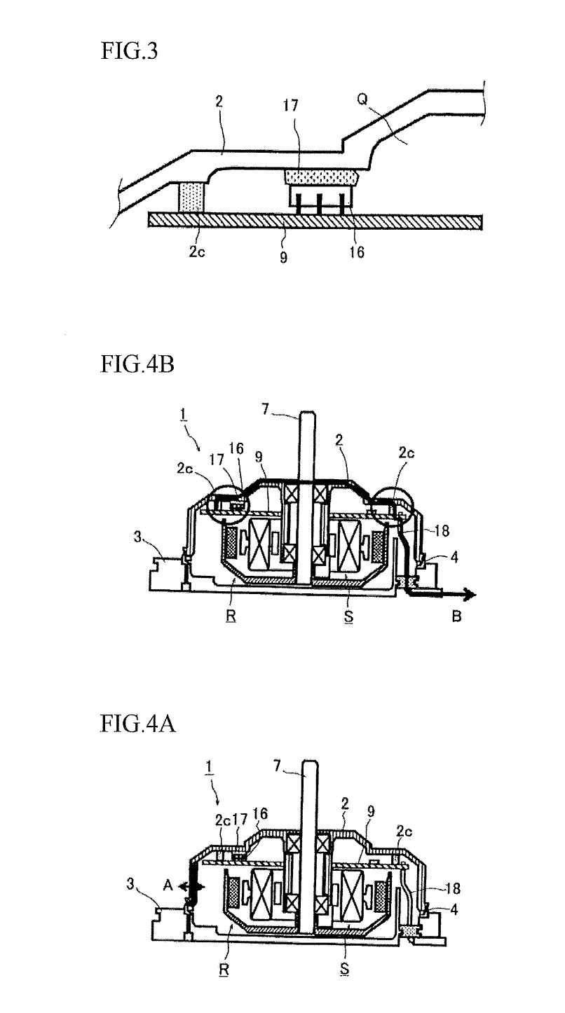

In FIG. 3, out of the electronic components mounted on the motor substrate 9, the FET 16 contacts the bracket 2 (i.e., the opening bottom portion 2b) via a heat-dissipating silicone member (an oil compound, rubber member, gel member, or the like) 17.

By doing so, heat from the heat-generating component (the FET 16) can be directly transferred to the bracket 2 via the heat-dissipating silicone member 17 and the heat generated by the other mounted components can be efficiently dissipated via the bracket 2 that is adjacent to the motor substrate 9. Even if heat is transferred to the bracket 2, the rotation of the fan 5 will produce a cooling air-flow that is incident on the bracket 2, and therefore such heat can be efficiently dissipated.

In FIG. 2, external wiring 18 is connected to the motor substrate 9. The external wiring 18 extends outside the motor via a grommet 19 that is fitted into a through-hole 3a provided in the attachment base 3. By including an earth wire in the external wiring 18, it is also possible to externally ground the motor substrate 9.

Also, in FIG. 4A, by fixing the motor substrate 9 to the opening bottom portion 2b of the bracket 2, motor vibration in the direction of the arrow A can be absorbed by the seal member 4, and therefore it is possible to protect the wiring connections.

Also, in FIG. 4B, the parts of the bracket 2 that contact the substrate (i.e., the boss portions 2c and the screws) are connected to the substrate wiring of the motor substrate 9 and the external wiring 18 is also connected to the substrate wiring. Therefore, as depicted by the arrow B, it is possible to connect the bracket 2 to earth via the substrate wiring of the motor substrate 9. This means that it is also possible to improve durability by avoiding electrical corrosion due to the accumulation of static electricity in the bearing portions 8a, 8b provided on the bracket 2.

As described above, since the motor substrate 9 is disposed within the area of the opening bottom portion 2b of the bracket opening 2a and within a range in the height in the axial direction inside the case that is closed and surrounded by the bracket 2 and the attachment base 3, it is possible to miniaturize and flatten the motor in the axial direction and to reduce the weight of the motor.

For a blower motor 1 with an output of around 50 W, for example, it is possible to achieve a reduction in the dimension between the bracket 2 and the attachment base 3 in the axial direction to around half and a reduction in weight to between around ⅔ and ½.

Since the bracket 2 and the attachment base 3 are sealed using the seal member 4, it is possible to provide a motor that is sufficiently water-resistant and vibration-proof to withstand an extreme usage environment where the motor is fitted in a vehicle.

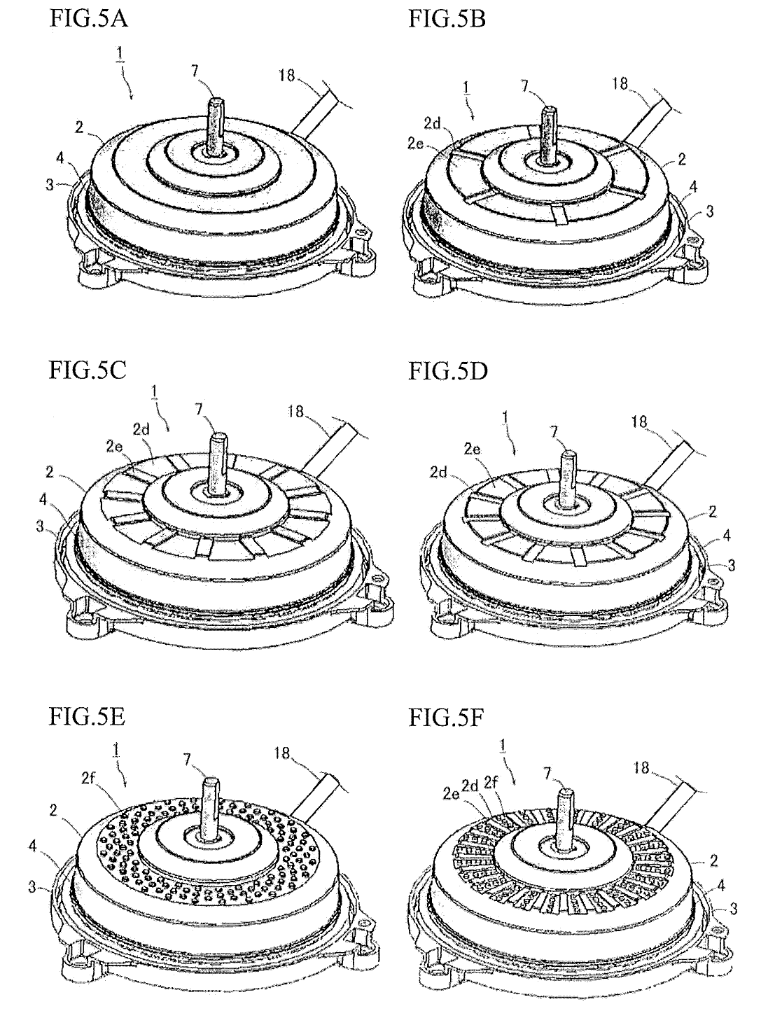

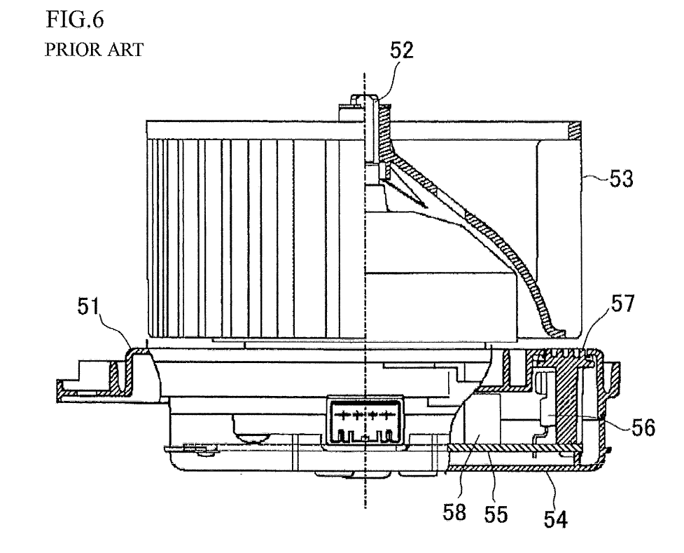

Variations of the form of the heat-dissipating surface of the bracket 2 will now be described with reference to FIGS. 5A to 5F. The heat-dissipating surface that is on the opposite side of the bracket 2 to the surface contacted by the heat-generating components may be a flat surface as depicted in FIG. 5A, but may alternatively be a concave and convex surface that has an increased surface area.

For example, radial channel portions 2d and flat portions 2e may be alternately formed on the heat-dissipating surface of the bracket 2 (see FIGS. 5B to 5D). As another example, dotted concave portions 2f may be formed in the heat-dissipating surface of the bracket 2 (see FIG. 5E). Alternatively, concave portions 2f may be formed in the radially formed channel portions 2d (see FIG. 5F).

As described above, by increasing the surface area of the heat-dissipating surface of the bracket 2, it is possible to improve the heat-dissipating performance.

Although a blower motor that is mounted in a vehicle is described in the above embodiment, the present invention is not limited to such, and it is also possible to apply the present invention to apparatuses aside from cooling apparatuses. Also, the present invention is not limited to an outer-rotor brushless motor and can also be applied to an inner-rotor brushless motor where the motor substrate is disposed between the rotor and stator and the bracket.

What is claimed is:

1. A blower motor comprising:
a motor case produced by attaching a cup-shaped bracket so as to cover an attachment base;
a motor shaft that protrudes out of the motor case; and
a fan that is attached to the motor shaft,
wherein a rotor and a stator are housed inside the motor case, a motor substrate, on which a motor driving circuit is formed, is disposed in a space formed in an axial direction between (i) the rotor and the stator and (ii) an opening bottom portion of the bracket, and a heat-generating component mounted on the motor substrate contacts the opening bottom portion of the bracket via a heat-dissipating member.

2. A blower motor according to claim 1,
wherein a heat-dissipating surface on an opposite side of the bracket to a surface contacted by the heat-generating component is formed with a convex and concave surface by forming at least one of radial channel portions and dotted concave portions.

3. A blower motor according to claim 1,
wherein the motor substrate is fixed next to the opening bottom portion of the bracket and the bracket is connected to earth by being connected to substrate wiring formed on the motor substrate.
